(19) United States
(12) Patent Application Publication
(10) Pub. No.: US 2008/0056457 A1
(43) Pub. Date: Mar. 6, 2008

(54) Mobile communication device and method of receiving voice on conference mode

(75) Inventor: Che-Wei Hsu, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/646,250

(22) Filed: Dec. 28, 2006

(30) Foreign Application Priority Data
Aug. 16, 2006 (TW) 095130161

(51) Int. Cl. H04M 1/64

(52) U.S. Cl. 379/88.03

(57) ABSTRACT

A mobile communication device includes a position setting module, a voice receiving module and a beamforming module. The position setting module sets a group of position parameters, and the voice receiving module receives a voice to generate at least one voice datum. The beamforming module adaptively adjusts a gain of the voice datum according to the position parameters so as to obtain a beamforming voice datum.

### BACKGROUND OF THE INVENTION

1. Field of Invention

The invention relates to a communication device, and, in particular, to a mobile communication device with an audio conference mode.

2. Related Art

Because personal electronic products are developing rapidly, the requirements on product quality, multi-functionality and portability have been greatly increased. As the electronic communications business develops daily, mobile communication devices have become indispensable personal electronic products. Mobile communication devices have various integrated functions. In addition to the basic telephone calling and receiving functions and miniature form, many additional functions are required. Of course, the required function of receiving voice signals while in audio conference mode is also required.

Recently, mobile communication devices generally have audio conference mode functionality. In the prior art, conventional conference call phones are usually used to hold audio conference calls. However, this audio conference call only can be made in the place of the phone's installation, and thus lacks the convenience of communicating with a mobile communication device.

Currently, a portable mobile communication device, such as a mobile phone, can be used to solve this problem. When the user enters the audio conference mode, he or she can switch the mobile phone into a hands-free function, in which the speaker of the mobile phone amplifies the volume, and the microphone is used to receive the voice so as to make a conference call. However, because the microphone used in the conventional mobile phone is very small and simple, it cannot effectively suppress the non-essential environmental noises. Thus, the communication quality of the audio conference mode is greatly deteriorated and the usefulness of the audio conference mode function is reduced. If the hardware is changed (e.g., a directional microphone is used) in order to enhance the communication quality, the space occupied by the hardware is enlarged, and the manufacturing cost of the hardware is also increased.

Thus, it is an important subject of the invention to provide a mobile communication device capable of filtering out non-essential environmental noises and enhancing the communication quality when conference calling mode is entered, and a method of voice reception while in conference mode.

### SUMMARY OF THE INVENTION

In view of the foregoing, the invention is to provide a mobile communication device capable of filtering out non-essential environmental noises and enhancing the communication quality when a conference mode is entered, and a method of receiving a voice on the conference mode.

To achieve the above, the invention discloses a mobile communication device including a position setting module, a voice receiving module and a beamforming module. In this invention, the position setting module sets a group of position parameters, the voice receiving module receives a voice to generate at least one voice datum, and the beamforming module adaptively adjusts a gain of the voice datum according to the group of position parameters so as to obtain a beamforming voice datum.

To achieve the above, the invention also discloses a method of receiving a voice while using a mobile communication device in conference mode. The method includes the following steps. First, a group of position parameters is set. Next, a voice is received to generate at least one voice datum. Finally, a gain of the voice datum is adaptively adjusted according to the group of position parameters so as to obtain a beamforming voice datum.

As mentioned above, the microphone of the voice receiving module receives the voice to generate the voice datum, and then the beamforming module adaptively adjusts the gain of the voice datum according to the group of position parameters set by the position setting module so as to obtain the beamforming voice datum in the mobile communication device and the method of receiving the voice while in the conference mode according to the invention. Compared with the prior art, non-essential environment noises can be suppressed and the quality of the conference call may become clearer when the conference proceeds because the beamforming voice datum generated by the beamforming module is adaptively adjusted in conjunction with the gain. For example, the required voice datum is multiplied by a gain of 1, and the unnecessary voice datum is multiplied by a gain of 0. In addition, using the algorithm of the beamforming module to filter out the noise of the voice datum can reduce the hardware cost and enhance the quality and function of the mobile communication device.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a mobile communication device according to a preferred embodiment of the invention;

FIGS. 2A to 2C are schematic illustrations respectively showing meeting room model parameters of conference environment parameters according to the preferred embodiment of the invention, wherein the meeting room model parameters include large meeting room model parameters, small meeting room model parameters and open space model parameters;

FIGS. 3A to 3B are schematic illustrations showing meeting table model parameters, including rectangular table model parameters and circular table model parameters, according to the preferred embodiment of the invention;

FIG. 4 is a schematic illustration showing a conference mode interface of the mobile communication device according to the preferred embodiment of the invention;

FIG. 5 is a schematic illustration showing a conference attendant position interface in the mobile communication device according to the preferred embodiment of the invention;

FIG. 6 is a flow chart showing a method of receiving a voice on a conference mode according to the preferred embodiment of the invention; and

FIG. 7 is a flow chart showing a step of FIG. 6 of adaptively adjusting a gain of a voice datum according to a group of position parameters so as to obtain a beamforming voice datum.

### DETAILED DESCRIPTION OF THE INVENTION

The present invention will be apparent from the following detailed description, which proceeds with reference to the accompanying drawings, wherein the same references relate to the same elements.

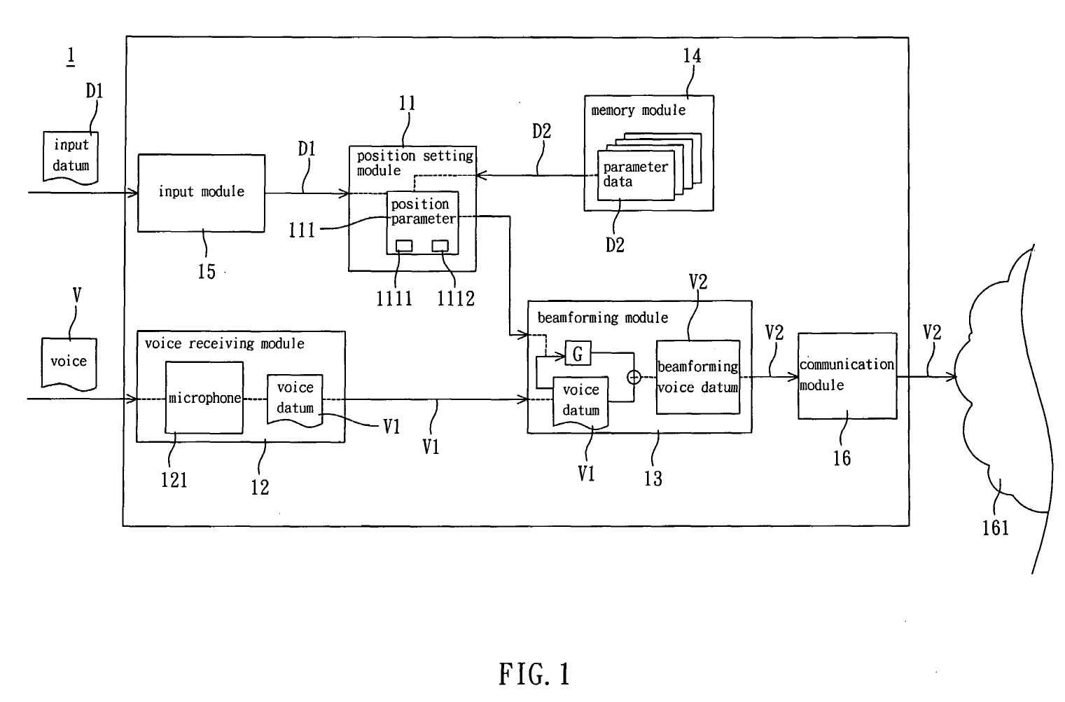

Referring to FIG. 1, a mobile communication device 1 according to a preferred embodiment of the invention includes a position setting module 11, a voice receiving module 12 and a beamforming module 13. The mobile communication device 1 of this embodiment may be, without being limited to, a mobile phone or a personal digital assistant. Herein, the device 1 is a mobile phone.

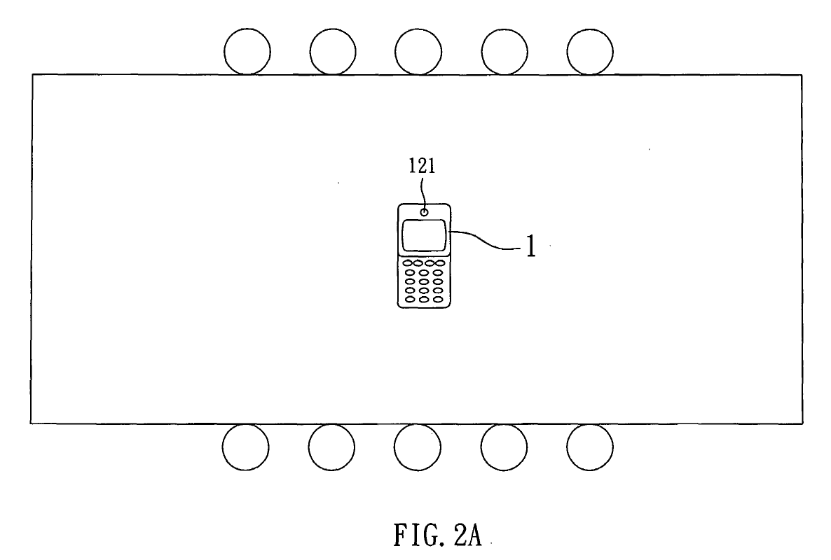

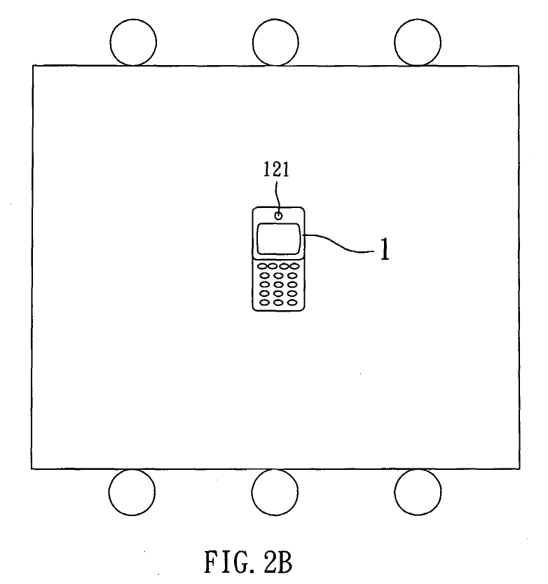

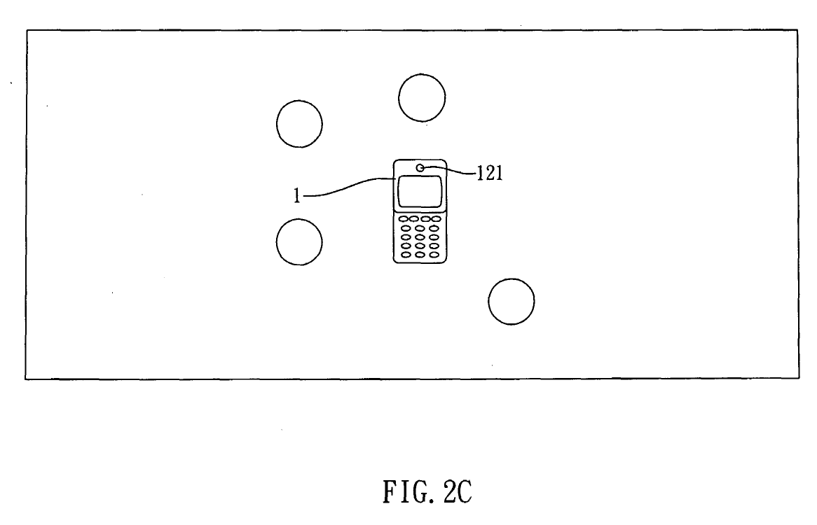

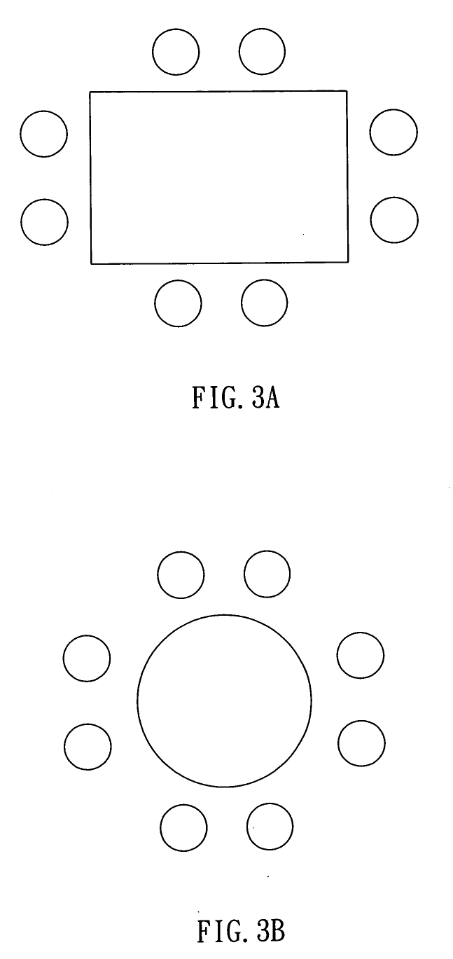

In this embodiment, the position setting module 11 sets a group of position parameters 111 including an attendant-number parameter 1111 and a conference environment parameter 1112. The attendant-number of this embodiment is not particularly limited and is determined according to the attendants of the conference. In addition, the conference environment parameter 1112 is a meeting room model parameter or a meeting table model parameter. The meeting room model parameter may be set to a large meeting room model parameter (see FIG. 2A), a small meeting room model parameter (see FIG. 2B) or an open space model parameter (see FIG. 2C). The meeting table model parameter may be set to a rectangular table (see FIG. 3A) or a circular table (see FIG. 3B). In addition, the meeting table model parameter can be set and then the positions of the attendants around the meeting table may be set manually or in a default manner.

In addition, the mobile communication device 1 of this embodiment further includes an input module 15 for inputting at least one input datum D1 and a memory module 14 for pre-storing a plurality of groups of parameter data D2, which are, for example, the data of the attendant-number parameter 1111, such as “4 to 6 attendants”, “6 to 8 attendants” or “8 to 12 attendants”, or the data of the conference environment parameter 1112 during implementation. In this embodiment, the position setting module 11 may select the attendant-number parameter 1111 and the conference environment parameter 1112 from among the plurality of groups of parameter data D2 according to the input datum D1 so as to set the group of position parameters 111. In addition, it is also possible to directly set the attendant-number parameter 1111, the conference environment parameter 1112 and the positions of the attendants according to the input datum D1.

Referring again to FIG. 1, the voice receiving module 12 of this embodiment has a microphone 121 for receiving a voice V from outside and generating at least one voice datum V1 through the microphone 121 according to the voice V. In this embodiment, the voice V is received according to the positions of the attendants. In addition, the voice datum V1 includes, without being limited to, an analog signal datum. In practice, the voice datum V1 is a file having an extension name of “wav” or “mp3”.

In this embodiment, the beamforming module 13 generates a gain G of the voice datum V1 according to the attendant-number parameter 1111 and the conference environment parameter 1112 of the group of position parameters 111, and then performs a beamforming operation according to the voice datum V1 and a predetermined algorithm so as to find the sound wave of the attendant in the voice datum V1 correctly and adaptively adjust the gain G thereof. That is, the gain G and the voice datum V1 are multiplied together to amplify the sound wave of the attendant of the voice datum V1 and to reduce other sound waves, such as background noises or other noises. Thus, a beamforming voice datum V2 corresponding to the voice datum V1 of the audio at the position may be obtained.

The mobile communication device of this embodiment further includes a communication module 16 for outputting the obtained beamforming voice datum V2 to a certain receiving end participating in this conference through a communication network 161. The communication network 161 of this embodiment includes, without being limited to, a hard-wired network, a wireless network, an infrared transmission or a mobile phone network.

The voice receiving operations of the mobile communication device 1 of this embodiment are described as follows. First, the at least one input datum D1 is received from the input module 15, and the position setting module 11 sets the group of position parameters 111 according to the input datum D1. When the group of position parameters 111 is being set, a plurality of groups of parameter data D2 stored in the memory module 14 may be selected to set the attendant-number parameter 1111 and the conference environment parameter 1112 of the position parameter 111 while obtaining the positions of the attendants. When the setting of the group of position parameters 111 is completed, the voice receiving module 12 receives a voice V through the microphone 121 of the voice receiving module 12 according to the positions of the attendants so as to generate the at least one voice datum V1. The beamforming module 13 receives the voice datum V1, generates the gain G of the voice datum V1 according to the attendant-number parameter 1111 and the conference environment parameter 1112, and multiplies the voice datum V1 by the gain G so as to obtain the beamforming voice datum V2. Then, the beamforming voice datum V2 is transferred to the receiving end through the communication network 161 using the communication module 16.

In order to make the contents of the invention clearer, an example of a mobile phone will be illustrated to describe the voice receiving operations during an audio conference of the mobile communication device 1 according to the preferred embodiment of the invention.

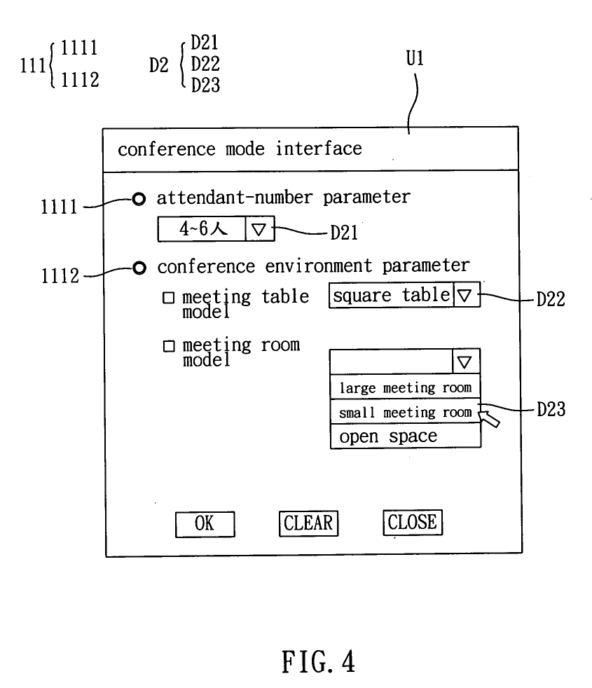

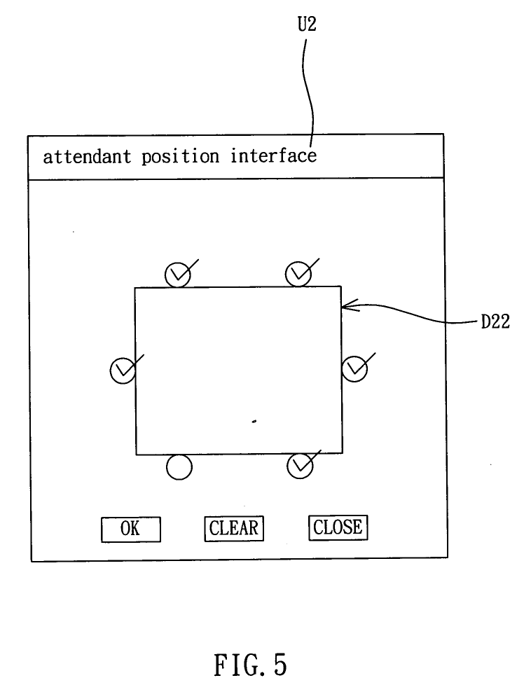

As shown in FIGS. 1 and 4, when the user wants to use the mobile communication device 1 to make an audio conference, a user interface will be displayed on a display frame of the mobile communication device 1 such that the user can set a group of position parameters 111. Herein, the user interface is a conference mode interface U1, as shown in FIG. 4. For example, if five attendants, such as LEE, WANG, CHIN, WU, and LIN, participate in the conference, the user can input at least one input datum D1 to set the position parameter 111 by inputting directly or via a pull-down menu through the conference mode interface U1. Herein, the plurality of groups of parameter data D2 stored in the memory module 14 serve as the default items of the pull-down menu. For example, the position parameter 111 of “4 to 6 attendants, D21” is selected through the pull-down menu, the meeting room model parameter of “small meeting room model parameter, D22” is selected from the conference environment parameter 1112, and the parameter of “rectangular table, D23” is selected from the meeting table model parameter. After the user has selected the table type of the meeting table model parameter, a display frame of an attendant position interface U2, as shown in FIG. 5, is displayed such that the user can set the positions of the attendants by way of directly clicking or in a default manner. Herein, the user clicks the seats in the display frame to set the positions of five attendants. After the setting is completed, the user can click “Finish” to jump back to the conference mode interface U1 such that other parameters can be selected. When the user finishes the setting of various parameters, he or she may click “Finish” to jump out of the conference mode interface U1. So, the input module 15 transfers the received input datum D1 to the position setting module 11 such that the position setting module 11 can set the position parameter 111 according to the input datum D1. When the position parameter 111 finishes the setting, the voice receiving operation of the audio conference can be performed.

As shown in FIG. 1, the voice receiving module 12 receives the voice of each attendant through the microphone 121 to generate and store the voice data V1. The beamforming module 13 respectively analyzes the gains G of the voice data V1 according to the attendant-number parameter 1111 and the conference environment parameter 1112 of the position parameter 111, and then multiplies the voice data V1 and the gains G thereof together to get the beamforming voice data V2 corresponding to the voice data V1. For example, in the voice datum V1 of the attendant “LIN”, the background noise and the sound wave pertaining to LIN are recognized, and the beamforming operation is performed according to the voice datum V1 of LIN and the predetermined algorithm to adaptively adjust the gain G thereof. That is, the sound wave of LIN and a value of the gain G, such as 1, are multiplied together to keep the sound wave of LIN, and the other noises and a value of the gain G, such as 0, are multiplied together to remove the background noise. Thus, the beamforming voice datum V2 of LIN, which is very clear and has no background noise, may be obtained. Finally, the beamforming voice data V2 is outputted through the communication network 161 using the communication module 16 so as to receive the voice during the audio conference.

The mobile communication device 1 adaptively adjusts the gain G of the voice datum V1, which is received by the microphone 121 of the voice receiving module 12, and obtains the beamforming voice datum V2 through the beamforming module 13 according to the group of position parameters 111, which includes the attendant-number parameter 1111 and the conference environment parameter 1112 and is set by the position setting module 11. So, when the conference is proceeding, the non-essential environmental noises can be suppressed and the quality of the conference call may thus become clearer because the enhanced beamforming voice datum V2 is received or transmitted. In addition, the noise of the voice datum is filtered out according to the processing algorithm of the beamforming module 13, so the manufacturing cost of the hardware can be reduced, and the quality and usage can be enhanced simultaneously.

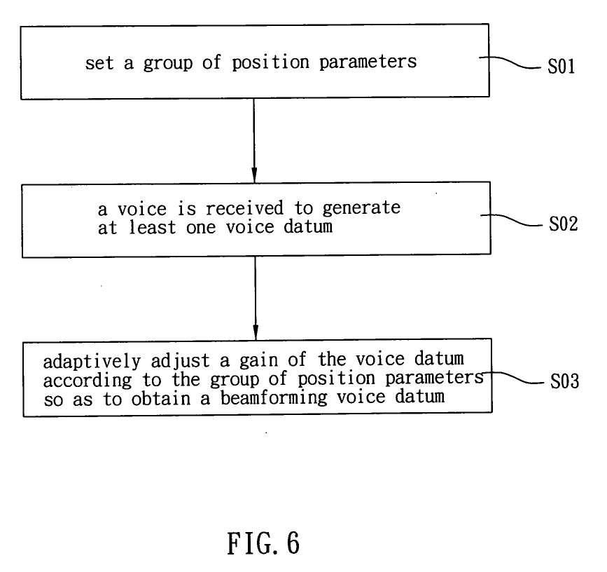

In addition, as shown in FIG. 6, the method of receiving the voice on a conference mode according to the preferred embodiment of the invention is applied to the mobile communication device 1 (FIG. 1) and includes steps S01 to S03.

First, in step S01, a group of position parameters 111 is set.

Next, in step S02, a voice V is received to generate at least one voice datum V1.

Finally, in step S03, a gain G of the voice datum V1 is adaptively adjusted according to the group of position parameters 111 so as to obtain a beamforming voice datum V2.

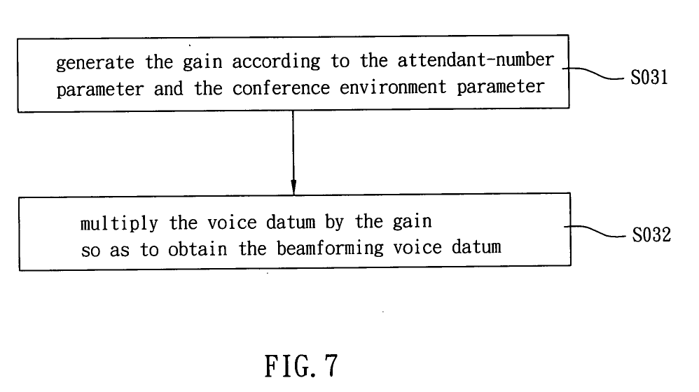

In addition, in order to make the invention be easily understood, step S03 of this embodiment will be described in detail. In step S03, this group of position parameters 111 includes an attendant-number parameter 1111 and a conference environment parameter 1112, and step S03 adaptively adjusts the gain G of the voice datum V1 according to this group of position parameters 111 so as to obtain the beamforming voice datum V2. Referring to FIG. 7, step S03 includes the following steps S031 and S032. In step S031, the gain G is generated according to the attendant-number parameter 1111 and the conference environment parameter 1112. In step S032, the voice datum V1 is multiplied by the gain G so as to obtain the beamforming voice datum V2.

Because the method of receiving a voice in conference mode in this embodiment can be applied to the mobile communication device 1 of FIG. 1, and the implementations and effects of the method have been discussed in the mobile communication device 1, detailed descriptions thereof will be omitted.

In summary, the microphone of the voice receiving module receives the voice to generate the voice datum, and then the beamforming module adaptively adjusts the gain of the voice datum according to the group of position parameters set by the position setting module so as to obtain the beamforming voice datum in the mobile communication device and the method of receiving the voice while in the conference mode according to the invention. Compared with the prior art, non-essential environment noises can be suppressed and the quality of the conference call may become clearer when the conference proceeds because the beamforming voice datum generated by the beamforming module is adaptively adjusted in conjunction with the gain. For example, the required voice datum is multiplied by a gain of 1, and the unnecessary voice datum is multiplied by a gain of 0. In addition, using the algorithm of the beamforming module to filter out the noise of the voice datum can reduce the hardware cost and enhance the quality and function of the mobile communication device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A mobile communication device, comprising:
a position setting module for setting a group of position parameters;
a voice receiving module for receiving a voice to generate at least one voice datum; and
a beamforming module for adaptively adjusting a gain of the voice datum according to the group of position parameters so as to obtain a beamforming voice datum.

2. The device according to claim 1, wherein the group of position parameters comprises an attendant-number parameter and a conference environment parameter, the beamforming module generates the gain according to the attendant-number parameter and the conference environment parameter, and multiplies the voice datum by the gain to obtain the beamforming voice datum, and the beamforming voice datum is the voice datum corresponding to audio from a specific position.

3. The device according to claim 2, wherein the conference environment parameter is a meeting room model parameter or a meeting table model parameter.

4. The device according to claim 3, wherein the meeting room model parameter is a large meeting room model parameter, a small meeting room model parameter or an open space model parameter.

5. The device according to claim 1, further comprising a memory module for storing a plurality of groups of parameter data, wherein the position setting module sets the group of position parameters according to the groups of the parameter data.

6. The device according to claim 1, further comprising an input module for inputting at least one input datum, wherein the position setting module sets the group of position parameters according to the input datum.

7. The device according to claim 1, wherein the voice receiving module has a microphone for receiving the voice and generating the voice datum according to the voice.

8. The device according to claim 1, wherein the voice datum is an analog signal datum.

9. The device according to claim 1, further comprising a communication module for outputting the beamforming voice datum through a communication network.

10. The device according to claim 1, wherein the beamforming module is a blind beamforming module.

11. A method of receiving a voice on a conference mode in a mobile communication device, the method comprising the steps of:
setting a group of position parameters;
receiving the voice to generate at least one voice datum; and
adaptively adjusting a gain of the voice datum according to the group of position parameters so as to obtain a beamforming voice datum.

12. The method according to claim 11, wherein the group of position parameters comprises an attendant-number parameter and a conference environment parameter, and the step of adaptively adjusting the gain of the voice datum comprises:
generating the gain according to the attendant-number parameter and the conference environment parameter; and
multiplying the voice datum by the gain so as to obtain the beamforming voice datum.

13. The method according to claim 12, wherein the conference environment parameter is a meeting room model parameter or a meeting table model parameter.

14. The method according to claim 13, wherein the meeting room model parameter is a large meeting room model parameter, a small meeting room model parameter or an open space model parameter.

15. The method according to claim 11, wherein the mobile communication device further comprises a memory module for storing a plurality of groups of parameter data, and the group of position parameters are set according to the groups of the parameter data.

16. The method according to claim 11, wherein the mobile communication device further comprises an input module for inputting at least one input datum, and the group of position parameters are set according to the input datum.

17. The method according to claim 11, wherein the voice receiving module has a microphone for receiving the voice and generating the voice datum according to the voice.

18. The method according to claim 11, wherein the voice datum is an analog signal datum.

19. The method according to claim 11 further comprising a step of:
outputting the beamforming voice datum.

20. The method according to claim 11, wherein the mobile communication device further comprises a communication module for outputting the beamforming voice datum through a communication network.
